(19) United States
(12) Patent Application Publication
(10) Pub. No.: US 2006/0152576 A1
(43) Pub. Date: Jul. 13, 2006

(54) Mobile communication device having detachable wireless camera and camera module for a mobile communication device

(75) Inventors: Michael Kiessling, Freising (DE); Kenneth A. Tuchman, Munich (DE)

Correspondence Address: HITT GAINES P.C., P.O. BOX 832570, RICHARDSON, TX, 75083, US

(73) Assignee: Agere Systems Incorporated, Allentown, PA (US)

(21) Appl. No.: 11/033,197

(22) Filed: Jan. 11, 2005

(51) Int. Cl. H04B 1/38

(52) U.S. Cl. 348/14.01

(57) ABSTRACT

A mobile communication device and a camera module configured to be attached to a suitable mobile communication device. In one embodiment, the device includes: (1) a main body having a radio frequency receiver and (2) a camera module detachably coupled to the main body and having a radio frequency transmitter, the radio frequency receiver and the radio frequency transmitter configured to cooperate to establish a radio frequency connection for transmitting data from the camera module to the main body.

### TECHNICAL FIELD OF THE INVENTION

The present invention is directed, in general, to a imaging, in particular to mobile imaging, and especially to a mobile communication device, which is provided with a camera module.

### BACKGROUND OF THE INVENTION

Mobile communication devices, such as wireless telephones, are increasingly used for more than just speech communication. A variety of applications like messaging services, data communication, e-mail or fax services have become available to the users of mobile communication devices.

The ongoing development in digital imaging devices furthermore makes it possible today to equip mobile communication devices with digital cameras at affordable prices, giving rise to new multimedia services. It therefore becomes possible to capture digital photographs or to record digital video clips and, for example, send them to another device by means of the well-known multimedia message system (MMS) or even to enable video conferencing functionality.

With ongoing miniaturization of digital imaging devices the resolution of such devices also constantly increases, but since imaging devices are integrated into the mobile communication device, an upgrade of the camera alone is not possible.

One known attempt for a more flexible use of an imaging device in combination with a mobile communication device (described, for example, in Japanese Patent Application Serial No. JP 2002135373 A) is to connect a camera and a mobile telephone by means of a cable, so that an image captured with the camera is displayed on the display of the mobile telephone, thereby providing viewfinder and display screen functionality for the camera.

However, a mobile telephone cannot be conveniently used to telephone while a camera is attached to it via cable. The point of using a signal cable is to separate the camera from the mobile telephone, so that it can be handled independently. For this purpose, though, the mobile telephone viewfinder function is not practical.

Accordingly, what is needed in the art is a new and improved approach to providing a mobile communication device with imaging means that can be used in a more flexible way and that can be easily upgraded.

### SUMMARY OF THE INVENTION

To address the above-discussed deficiencies of the prior art, the present invention provides, in one aspect, a mobile communication device. In one embodiment, the device includes:

(1) a main body having a radio frequency receiver and (2) a camera module detachably coupled to the main body and having a radio frequency transmitter, the radio frequency receiver and the radio frequency transmitter configured to cooperate to establish a radio frequency connection for transmitting data from the camera module to the main body.

In another aspect, the present invention provides a camera module. In one aspect, the camera module includes: (1) a main body interface configured to allow the camera module to be attached to a mobile communication device having a complementary interface and a radio frequency receiver and (2) a radio frequency transmitter for transmitting digital image data to the mobile communication device.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the invention, reference is now made to the following descriptions taken in conjunction with the accompanying drawing, in which:

FIG. 1 illustrates a schematic front view of one embodiment of a mobile communication device with a detachable camera module constructed according to the principles of the present invention;

FIG. 2 illustrates a schematic front view of the mobile communication device of FIG. 1 with the camera module in a detached position;

FIG. 3 illustrates a schematic front view of another embodiment of a mobile communication device having a camera module that is provided with a built-in tripod constructed according to the principles of the present invention;

FIG. 4 illustrates a schematic front view of still another embodiment of a mobile communication device with a retractable camera module constructed according to the principles of the present invention; and

FIG. 5 illustrates a schematic side view of one embodiment of a mobile communication device with a main body and camera module thereof having a rechargeable battery.

### DETAILED DESCRIPTION

The invention proposes a mobile communication device, which may be a mobile telephone, personal digital assistant (PDA) or mobile digital assistant (MDA), that includes a main body having a radio frequency (RF) receiver, and a camera module detachable from the main body that has an RF transmitter, so that an RF connection between the main body and the camera module can be established and data can be transmitted from the camera module to the main body. The mobile communication device can be used for mobile telephones as well as for PDA or MDA style devices or any other, including future, mobile communication devices.

By establishing an RF connection between the camera module and the main body of the mobile communication device the transmission of preview, still image or video data from a separately handled camera module to the main body acting as base unit may be achieved in a convenient manner. Especially for the preview function, the transmission advantageously may be performed in real-time.

For transmitting control data, for example commands being entered via a keypad by the user, the camera module may be provided with an RF receiver and the main body may be also provided with an RF transmitter. The combination of transmitter and receiver may be provided as a mutual transceiver unit.

To decrease power consumption, a short range RF link may be used for the RF connection between the main body and the camera module. Technologies that can be used for this purpose comprise Bluetooth, Wireless USB, or any other similar current or future technology.

The camera module may have its own rechargeable battery, which may be charged while the main body of the mobile communication device mobile is charged and using the same power supply unit.

For charging the battery, the camera module may be attached to the main body. For this purpose, the camera module and the main body may be provided with complementary interfaces suitable for attaching the camera module to the main body. The interfaces may be provided with an appropriate electrical interfaces for charging the battery of the camera module through the main body of the mobile communication device.

The interfaces may include an interface for exchanging digital data, so that the RF data connection may be not needed, when the camera module may be attached to the main body by means of the interfaces.

To enable the camera module to be used for a certain time without being attached to the main body and without an established RF connection, the camera module may be provided with a non-volatile memory unit for storing digital image data.

For storage purposes, the main body of the mobile communication device may be provided with a non-volatile memory unit. For easy access to stored digital data, the memory unit can advantageously comprise a card reader unit adapted for use with flash memory cards like for example Compact Flash Type I or II, Smart Media, Multimedia Card or other future non-volatile memory cards.

For transfer of stored digital image data and further processing on a computer, the mobile communication device may include a computer interface for connecting the device to a computer. This connection can be established using a cable or any suitable wireless connection like for example infrared, Bluetooth, Wireless USB or other future short link RF technologies.

The mobile communication device may also include a memory with a stored software program and a microprocessor by which the software program can be executed. The software program and microprocessor can be adapted to control the camera module via the RF connection and to display image data received from the camera module on a display integrated in the main body of the mobile communication device.

For practical purposes, the camera module may be provided with a viewfinder, which may be especially of advantage when handling the camera module independently from the main body of the device.

The camera module may be retractable into the main body of the device. For this purpose the mobile communication device may advantageously include a spring with a user-releasable retainer for holding the camera module in a retracted position. The spring may be used to automatically transport the camera module from the retracted position to an exposed position, for example by means of a linear guiding. By keeping the camera module in a retracted position when not in use, it may be protected against external influences, especially the lens of the camera against scratches. The retainer may, for example, be released by the user by pushing an according button.

Especially when capturing images with long exposure times, blurred pictures may result. Therefore it may be advantageous to place the camera module on some kind of support, for example to mount it on a tripod. Accordingly, the camera module may be provided with a built-in tripod, on which in particular the camera module may be movably mounted, especially so that the camera module may be rotatable about at least one axis of rotation.

In this respect, the device may include a self-timer located in the camera module to automatically capture an image, a series of images or a video sequence after a certain delay time. The elapsing of the delay time can be indicated by appropriate indicating means, as for example by an LED, which flashes with an ascending frequency during the delay time. The camera may also include a flash to allow it to take photographs in dark surroundings.

A separate mobile communication device and a separate camera module, which are respectively provided with complementary interfaces for attaching the one to the other also lie within the scope of the present invention. For transmitting digital data to a mobile communication device the camera module may be further provided at least with an RF transmitter, and for receiving digital image data from a camera module the mobile communication device may be further provided at least with an RF receiver. For enabling two-way data exchange the mobile communication device and the camera module are provided with an RF transceiver (combination transmitter and receiver).

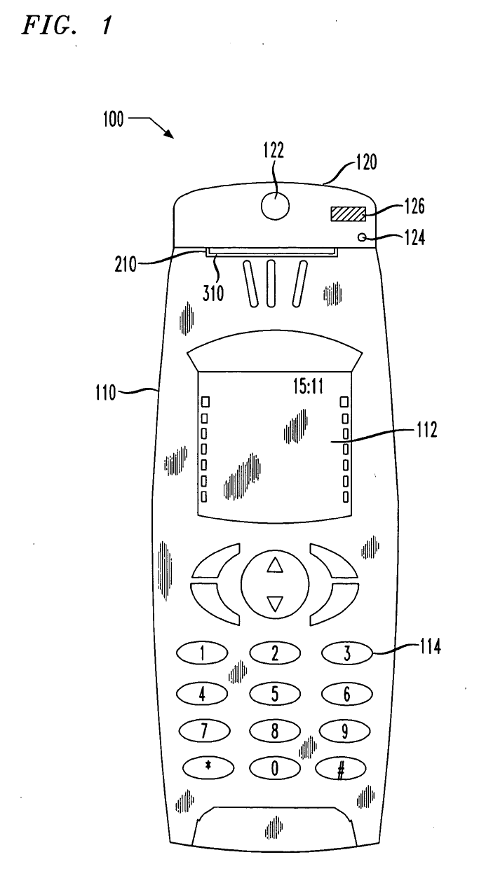

With these features and alternatives in mind, Reference will now be made to FIG. 1, which illustrates a mobile telephone 100. The mobile telephone is illustrated as being equipped with a camera module 120 attached to the main body 110. The camera module 120 is provided with a lens 122 for focusing incoming light onto an integrated image sensor for capturing digital images. In this embodiment, the camera module 120 further comprises a flash 126 and a timer (not shown), which is connected to an LED 124 for indicating the elapsing of the delay time of the timer.

The camera module 120 is attached to the main body 10 by complementary interfaces: a main body interface 210 and a camera module interface 310, which can for example comprise a snap mechanism. The main body and camera module interfaces 210, 310 may be further provided with an electrical interface for exchanging digital data between the main body 110 and the camera module 120 of the device 100, thereby enabling images captured with the camera module 120 to be displayed on the display 112 integrated in the main body 110 and commands entered by the user by means of the keypad 114 to be transferred to the camera module 120.

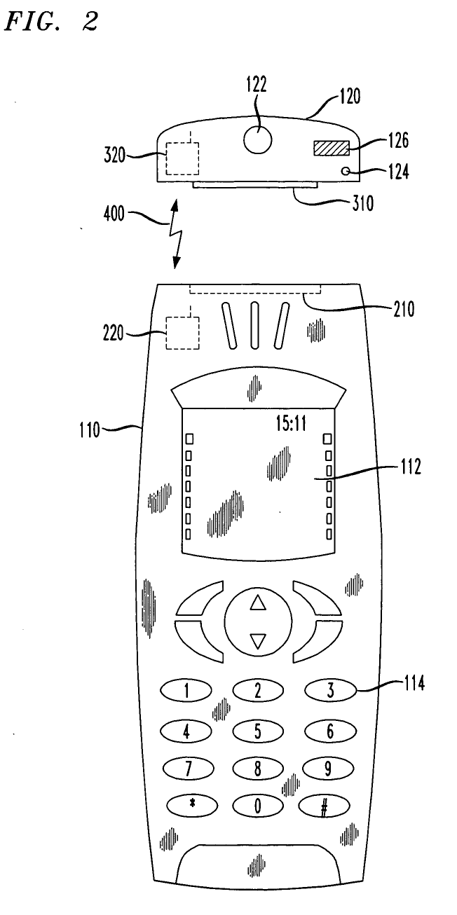

The main body and camera module interfaces 210, 310 allow the camera module 120 to be detached from the main body 110 as can be seen in FIG. 2, which shows the embodiment of FIG. 1 with the camera module 120 detached from the main body 110. For exchanging digital data when the camera module 120 is detached, the main body 110 and the camera module 120 are provided with RF transceivers 220, 320 respectively. Between the RF transceivers 220, 320 an RF link 400 can be established, for example on the basis of Bluetooth or wireless USB standards. Since the camera module 120 is detachable from the main body 110 of the device 100, updating the camera module 120, for example to obtain a camera module with higher resolution, can be achieved with minimal effort.

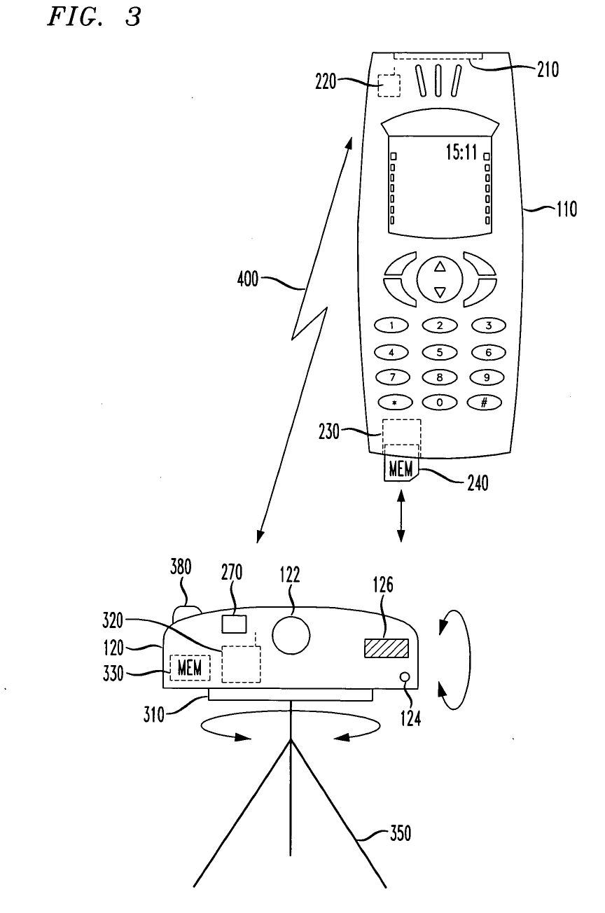

Turning now to FIG. 3, illustrated is a schematic front view of another preferred embodiment of an inventive mobile communication device provided with further preferred refinements. In this embodiment, the main body 110 is further provided with a card reader unit 230 adapted for use with a flash memory card 240 for easy storage of digital image data and convenient transfer to other devices. The camera module 120 in this embodiment is provided with an integrated non-volatile memory 330 for storing digital image data. This is especially advantageous when handling the camera module 120 independently from the main body 110 without an established RF connection, for example when using the camera module 120 in a distance from the main body 110 that exceeds the maximum working distance of the RF connection, e.g., Bluetooth. An advantage of using the camera module 120 independently from the main body 110 is, for example, to be able to use the mobile communication device 100 simultaneously for telephony. For example, a first user could handle the camera module 120 and a second user could at the same time make a telephone call by means of the main body 110.

The camera module 120 may further be provided with a viewfinder 370, since for this purpose the display 112 of the main body 110 cannot practically be used as a viewfinder. Also the command for shutter release or for activating image capturing cannot be given via the keypad 114 of the main body 110 without an established RF connection, therefore in this embodiment the camera module 120 is further provided with an activation or shutter release button 380.

A further embodiment includes a tripod 350 integrated in the camera module 120. The tripod 350 is provided with a bearing that allows the camera module 120 to rotate about a vertical axis of rotation and to tilt about an axis perpendicular thereto, so that the view of the camera module 120 can be adjusted according to a user's needs.

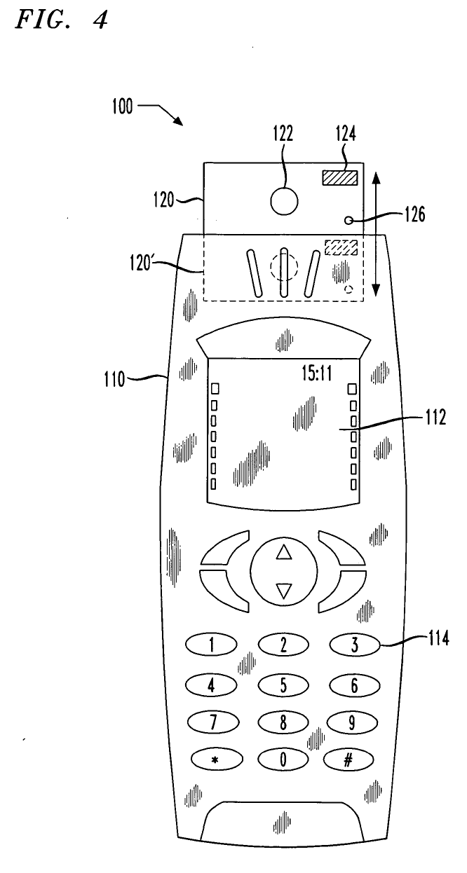

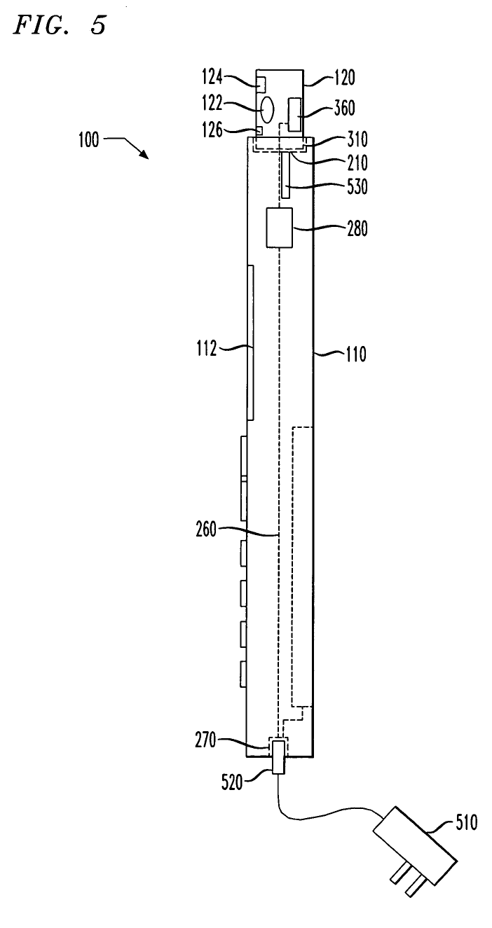

Turning now to FIG. 4, illustrated is another embodiment of an inventive mobile communication device in which the camera module 120 is retractable into the main body 110 of the device. In a retracted position 120′ the camera module 120 is protected against damages, especially scratches of the lens 122. A linear guiding is provided to transport the camera module 120 from a fixed retracted position 120′ to a fixed exposed position and vice versa. In the exposed position, the camera module 120 can be used to capture images while attached to the main body 110, but can also be detached from the main body 110 as described above. Alternatively the camera module 120 can become detached from the main body 110 automatically when moved from the retracted position 120′. For this purpose, the mobile communication device 100 can comprise a spring and retainer 530 (see FIG. 5), by which the camera module 120 can be automatically ejected and thus become detached from the main body 110 when the user so desires.

Turning now to FIG. 5, illustrated is a schematic side view of still another preferred embodiment of an inventive mobile communication device 100 with the main body 110 and the camera module 120 both being provided with rechargeable batteries 260 and 360 respectively, which can be charged simultaneously by means of the same power supply unit 510. The power supply unit 510 may be provided with a plug connector 520, and the main body 110 may be provided with a corresponding power supply jack 270. The power supply jack 270 is internally connected to a battery 260 and to the electrical interface integrated in the main body and camera module interfaces 210, 310 and thereby the battery 360. This way both the batteries 260, 360 of the camera module 20 and of the mobile telephone 110 itself can be charged with only one charge unit 510.

Although the present invention has been described in detail, those skilled in the art should understand that they can make various changes, substitutions and alterations herein without departing from the spirit and scope of the invention in its broadest form.

What is claimed is:

1. A mobile communication device, comprising:
a main body having a radio frequency receiver, and
a camera module detachably coupled to said main body and having a radio frequency transmitter, said radio frequency receiver and said radio frequency transmitter configured to cooperate to establish a radio frequency connection for transmitting data from said camera module to said main body.

2. The device as recited in claim 1 wherein said device is selected from the group consisting of:
a mobile telephone,
a personal digital assistant, and
a mobile digital assistant.

3. The device as recited in claim 1 wherein said main body further has a radio frequency transmitter, said camera module further has radio frequency receiver and said radio frequency connection is capable of transmitting data from said camera module to said main body.

4. The device as recited in claim 1 wherein said camera module further has a rechargeable battery.

5. The device as recited in claim 4 wherein said camera module and said main body are provided with complementary interfaces for attaching said camera module to said main body and said interfaces are provided with a plug connector and a power supply jack for charging said battery of said camera module through said main body of said mobile communication device.

6. The device as recited in claim 1 wherein said radio frequency connection is a short-range radio frequency connection.

7. The device as recited in claim 6 wherein said short link RF connection is selected from the group consisting of:
a Bluetooth connection, and
a wireless universal serial bus.

8. The device as recited in claim 1 wherein one of said camera module and said main body is provided with a non-volatile memory unit for storing digital image data.

9. The device as recited in claim 8 further comprising a computer interface configured to allow said device to be connected to a computer.

10. The device as recited in claim 1 further comprising a display configured to display image data received from said camera module via said radio frequency connection.

11. The device as recited in claim 1 wherein said camera module has a viewfinder.

12. The device as recited in claim 1 further comprising user releasable retaining means for holding said camera module in a retracted position and transporting means to automatically transport said camera module from said retracted position to an exposed position.

13. The device as recited in claim 1 wherein said camera module has a built-in tripod.

14. The device as recited in claim 1 wherein said camera module has a flash.

15. The device as recited in claim 1 further comprising:
a user-activatable timer configured to automatically take a photograph after a certain delay time; and
an indicator for indicating an elapsing of said delay time.

16. A camera module, comprising:
a main body interface configured to allow said camera module to be attached to a mobile communication device having a complementary interface and a radio frequency receiver; and
a radio frequency transmitter for transmitting digital image data to said mobile communication device.

17. The camera module as recited in claim 16 further comprising a radio frequency receiver for receiving digital control data from said device, said device having a radio frequency transmitter.
